(19) United States
(12) Patent Application Publication
(10) Pub. No.: US 2007/0162180 A1
(43) Pub. Date: Jul. 12, 2007

(54) Inventory method for automated data storage library with packed cartridges

(75) Inventors: Brian G. Goodman, Tucson, AZ (US); Leonard G. Jesionowski, Tucson, AZ (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/328,555

(22) Filed: Jan. 10, 2006

(51) Int. Cl. G06F 7/00

(52) U.S. Cl. 700/225

(57) ABSTRACT

An automated data library system employs a plurality of cartridges, a slot physically configured to store the cartridges, and a library controller operable to build a slot inventory of the slot storing the plurality of cartridges. The building of the slot inventory includes the library controller generating slot inventory data including cartridge identification information of each cartridge behind a lead cartridge in the slot, and the library controller writing a slot inventory including the slot inventory data to a cartridge memory of the lead cartridge.

### FIELD OF INVENTION

The present invention generally relates to inventory methods for automated data storage libraries. The present invention specifically relates to automated data storage libraries that offer increased storage capacity by storing data storage media in three dimensions.

### BACKGROUND OF THE INVENTION

Automated data storage libraries are known for providing cost effective storage and retrieval of large quantities of data. The data in automated data storage libraries is stored on data storage media that are, in turn, stored on storage shelves or the like inside the library in a fashion that renders the media, and its resident data, accessible for physical retrieval. Such media is commonly termed “removable media.” Data storage media may comprise any type of media on which data may be stored and which may serve as removable media, including but not limited to magnetic media (such as magnetic tape or disks), optical media (such as optical tape or disks), electronic media (such as ROM, PROM, EEPROM, flash PROM, MRAM, CompactFlash™, SmartMedia™, Multi Media Card™, Secure Digital™, xD-Picture Card™, Memory Stick™, etc.), or other suitable media. Typically, the data stored in automated data storage libraries is resident on data storage media that is contained within a cartridge and referred to as a data storage media cartridge. An example of a data storage media cartridge that is widely employed in automated data storage libraries for mass data storage is a magnetic tape cartridge.

In addition to data storage media, automated data storage libraries typically contain data storage drives that store data to, and/or retrieve data from, the data storage media. The transport of data storage media between data storage shelves and data storage drives is typically accomplished by one or more robot accessors (hereinafter termed “accessors”). Such accessors have grippers for physically retrieving the selected data storage media from the storage shelves within the automated data storage library and transport such media to the data storage drives by moving in the X and Y directions.

Some library designs provide multiple cartridges per slot, where a first cartridge needs to be moved to get to a second cartridge substantially behind the first cartridge. For example, a long slot that holds two or more cartridges. One problem with this storage approach is that library inventory is more difficult. This is because the library must move a first cartridge to read the bar code label of a cartridge behind it. One approach is to save the inventory contents in a nonvolatile table in the library. A problem with this approach is that a loss of the nonvolatile table would result in a loss of the entire inventory, and this could take many hours or days to rebuild, depending on the storage capacity, mount rate, and bar code scan rate of the library. Backup tables could be used but a logic or firmware error, or a loss of the primary and the backup table, could result a total loss of inventory, thus requiring the same long recovery process.

What is needed is an improved method of maintaining the inventory of such a library.

### SUMMARY OF THE INVENTION

The present invention provides a new and unique inventory method for an automated data storage library with packed cartridges.

One form of the present invention is a signal bearing medium tangibly embodying a program of machine-readable instructions executed by a processor to perform operations for building a slot inventory of the slot storing the plurality of cartridges. The operations comprise a generation of slot inventory data including cartridge identification information of each cartridge behind a lead cartridge in the slot, and a writing of the slot inventory including the slot inventory data to a cartridge memory of the lead cartridge.

A second form of the present invention is a library controller of an automated data storage library. The library controller comprises a processor and a memory storing instructions operable within the processor for building a slot inventory of the slot storing the plurality of cartridges. The instructions being executed for generating slot inventory data including cartridge identification information of each cartridge behind a lead cartridge in the slot, and writing the slot inventory including the slot inventory data to a cartridge memory of the lead cartridge.

A third form of the present invention is An automated data library system comprising a plurality of cartridges, a slot physically configured to store the cartridges, and a library controller operable to build a slot inventory of the slot storing the plurality of cartridges. The building of the slot inventory includes the library controller generating slot inventory data including storage location information of each cartridge behind a lead cartridge in the slot, and the library controller writing the slot inventory including the slot inventory data to a cartridge memory of the lead cartridge.

The forgoing forms and other forms as well as well as objects, features and advantages of the present invention will become further apparent from the following detailed description of the various embodiments of the present invention, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 is an isometric view of an automated data storage library adaptable to implement an embodiment of the present invention, with the view specifically depicting a library having a left hand service bay, multiple storage frames and a right hand service bay;

FIG. 2 is an isometric view of an automated data storage library adaptable to implement an embodiment of the present invention, with the view specifically depicting an exemplary basic configuration of the internal components of a library;

FIG. 3 is a block diagram of an automated data storage library adaptable to implement an embodiment of the present invention, with the diagram specifically depicting a library that employs a distributed system of modules with a plurality of processor nodes;

FIG. 4 is a block diagram depicting an exemplary controller configuration;

FIG. 5 is an isometric view of the front and rear of a data storage drive adaptable to implement an embodiment of the present invention;

FIG. 6 is an isometric view of a data storage cartridge adaptable to implement an embodiment of the present invention;

FIG. 7 illustrates isometric view of a gripper adaptable to implement an embodiment of the present invention;

FIG. 8 illustrates a flowchart representative of one embodiment of a library inventory method in accordance with the present invention;

FIG. 9 illustrates a flowchart representative of one embodiment of a build slot inventory method in accordance with the present invention;

FIG. 10 illustrates a block diagram of one embodiment of a slot inventory system in accordance with the present invention;

FIG. 11 illustrates an exemplary slot inventory in accordance with the present invention;

FIG. 12 illustrates a flowchart representative of a first embodiment of a slot inventory modification method in accordance with the present invention;

FIG. 13 illustrates a flowchart representative of a second embodiment of a slot inventory modification method in accordance with the present invention;

FIG. 14 illustrates a flowchart representative of a first embodiment of a slot inventory rebuilding trigger method in accordance with the present invention; and

FIG. 15 illustrates a flowchart representative of a second embodiment of a slot inventory rebuilding trigger method in accordance with the present invention.

### DETAILED DESCRIPTION OF THE PRESENT INVENTION

This invention is described in preferred embodiments in the following description with reference to the Figures, in which like numerals represent the same or similar elements. While this invention is described in terms of the best mode for achieving this invention's objectives, it will be appreciated by those skilled in the art that it is intended to cover alternatives, modifications, and equivalents as may be included within the spirit and scope of the invention as defined by the appended claims.

The invention will be described as embodied in an automated magnetic tape library storage system for use in a data processing environment. Although the invention shown uses magnetic tape cartridges, one skilled in the art will recognize the invention equally applies to optical disk cartridges or other removable storage media and the use of either different types of cartridges or cartridges of the same type having different characteristics. Furthermore the description of an automated magnetic tape storage system is not meant to limit the invention to magnetic tape data processing applications as the invention herein can be applied to any media storage and cartridge handling systems in general.

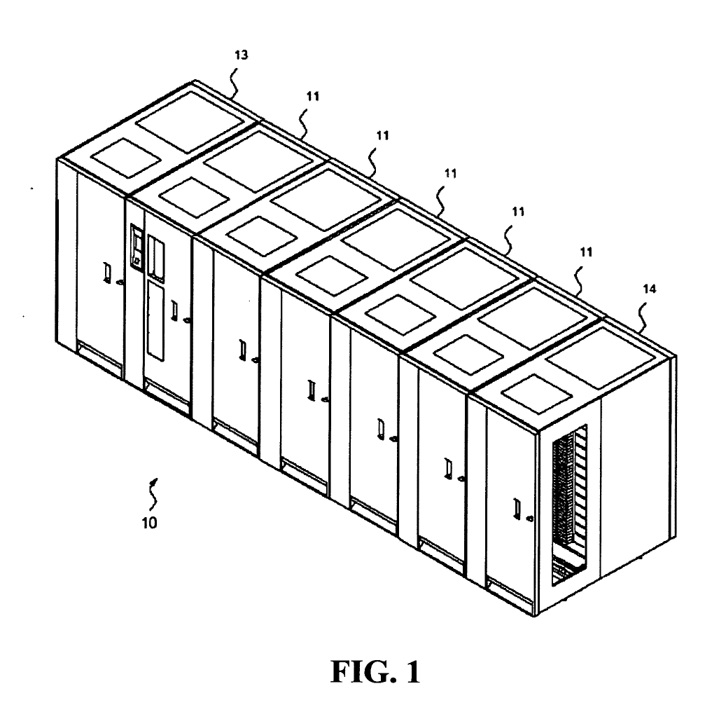

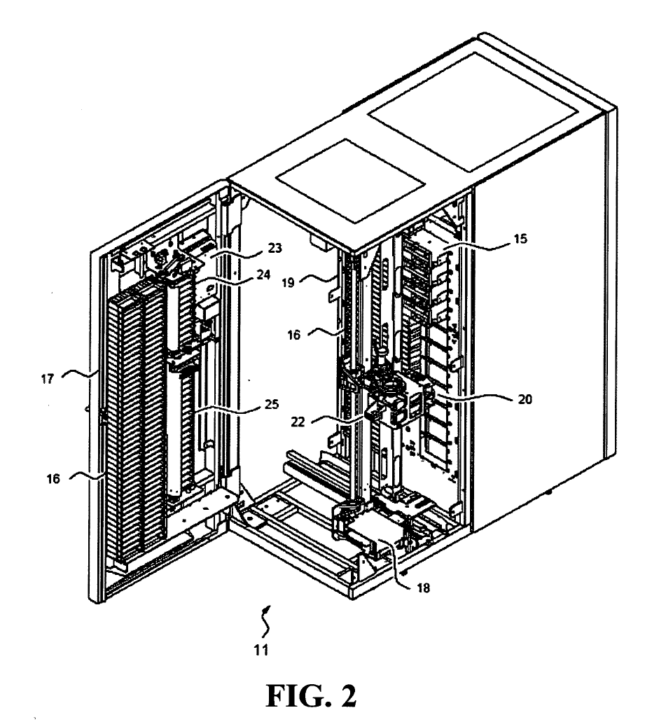

Turning now to the Figures, FIGS. 1 and 2 illustrate an automated data storage library 10 which stores and retrieves data storage cartridges containing data storage media (not shown) in storage shelves 16. It is noted that references to “data storage media” herein refer to data storage cartridges, and for purposes herein the two terms are used synonymously. An example of an automated data storage library which may implement the present invention, and has a configuration as depicted in FIGS. 1 and 2, is the IBM 3584 UltraScalable Tape Library. The library of FIG. 1 comprises a left hand service bay 13, one or more storage frames 11, and right hand service bay 14. As will be discussed, a frame may comprise an expansion component of the library. Frames may be added or removed to expand or reduce the size and/or functionality of the library. Frames may comprise additional storage shelves, drives, import/export stations, accessors, operator panels, etc.

FIG. 2 shows an example of a storage frame 11, which is the base frame of the library 10 and is contemplated to be the minimum configuration of the library. In this minimum configuration, there is only a single accessor (i.e., there are no redundant accessors) and there is no service bay. The library 10 is arranged for accessing data storage media in response to commands from at least one external host system (not shown), and comprises a plurality of storage shelves 16 on front wall 17 and rear wall 19 for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The data storage drives 15 may be optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18.

As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or other reading system, such as a cartridge memory reader or similar system, mounted on the gripper 20, to “read” identifying information about the data storage media.

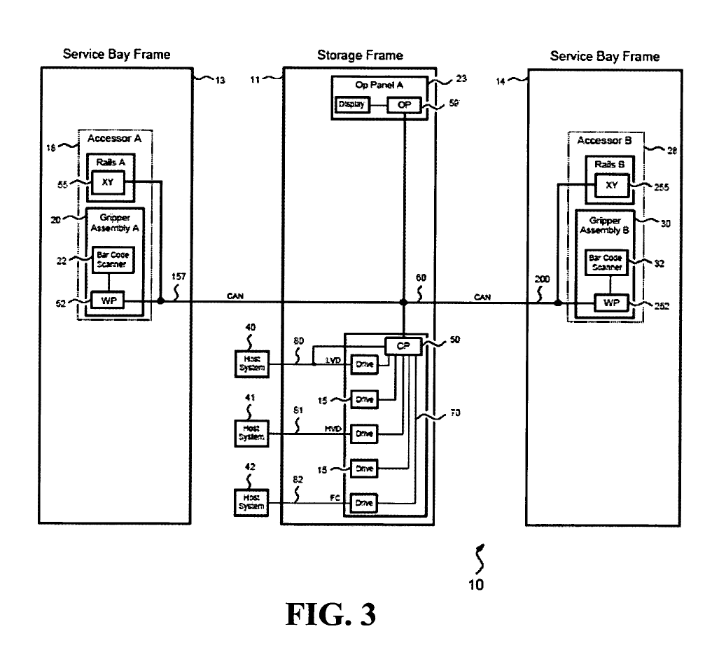

FIG. 3 illustrates an embodiment of an automated data storage library 10 of FIGS. 1 and 2, which employs a distributed system of modules with a plurality of processor nodes. An example of an automated data storage library which may implement the distributed system depicted in the block diagram of FIG. 3, and which may implement the present invention, is the IBM 3584 UltraScalable Tape Library. For a fuller understanding of a distributed control system incorporated in an automated data storage library, refer to U.S. Pat. No. 6,356,803, which is entitled “Automated Data Storage Library Distributed Control System,” which is incorporated herein for reference.

While the automated data storage library 10 has been described as employing a distributed control system, the present invention may be implemented in automated data storage libraries regardless of control configuration, such as, but not limited to, an automated data storage library having one or more library controllers that are not distributed, as that term is defined in U.S. Pat. No. 6,356,803. The library of FIG. 3 comprises one or more storage frames 11, a left hand service bay 13 and a right hand service bay 14. The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41 or 42. The host systems, such as host servers, may communicate with the library directly, e.g., on path 80, through one or more control ports (not shown), or through one or more-data storage drives 15 on paths 81, 82, providing commands to access particular data storage media and move the media, for example, between the storage shelves 16 and the data storage drives 15. The commands are typically logical commands identifying the media and/or logical locations for accessing the media The terms “commands” and “work requests” are used interchangeably herein to refer to such communications from the host system 40, 41 or 42 to the library 10 as are intended to result in accessing particular data storage media within the library 10.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent connections or networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, host connections 80 and 81 are SCSI busses. Bus 82 comprises an example of a Fibre Channel bus which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

Further, as described above, the automated data storage library 10 may comprise a plurality of accessors. A second accessor 28, for example, is shown in a right hand service bay 14 of FIG. 3. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 3 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

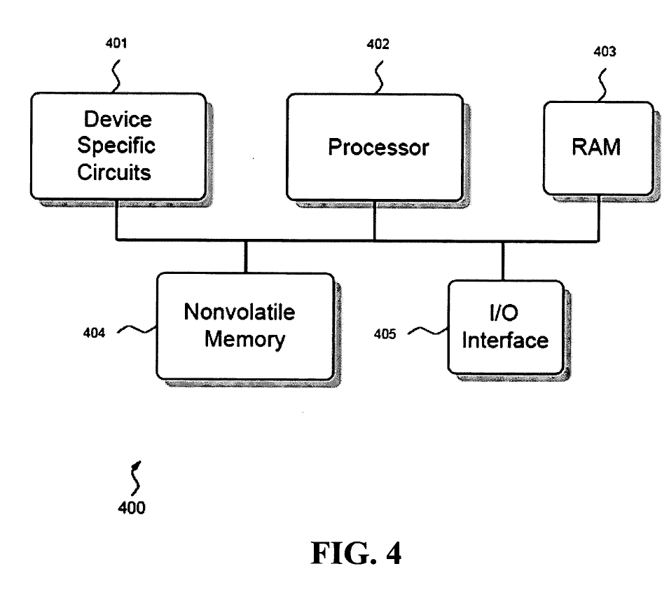

An automated data storage library 10 typically comprises one or more controllers to direct the operation of the automated data storage library. Host computers and data storage drives typically comprise similar controllers. A controller may take many different forms and may comprise, for example but not limited to, an embedded system, a distributed control system, a personal computer, or a workstation. Essentially, the term “controller” as used herein is intended in its broadest sense as a device that contains at least one processor, as such term is defined herein. FIG. 4 shows a typical controller 400 with a processor 402, RAM (Random Access Memory) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, FPGA (Field Programmable Gate Array), ASIC (Application Specific Integrated Circuit), discrete logic, or the like. The RAM (Random Access Memory) 403 is typically used to hold variable data, stack data, executable instructions, and the like. The nonvolatile memory 404 may comprise any type of nonvolatile memory such as, but not limited to, ROM (Read Only Memory), PROM (Programmable Read Only Memory), EEPROM (Electrically Erasable Programmable Read Only Memory), flash PROM (Programmable Read Only Memory), MRAM (Magnetoresitive Random Access Memory), battery backup RAM, hard disk drives, floppy disk drives, CompactFlash (CF)™, SmartMedia™, Memory Stick™, Multi Media Card (MMC)™, Secure Digital (SD)™, xD-Picture Card™, etc. The nonvolatile memory 404 is typically used to hold the executable firmware and any nonvolatile data. The I/O interface 405 comprises a communication interface that allows the processor 402 to communicate with devices external to the controller. Examples may comprise, but are not limited to, RS-232 (Recommended Standard), USB (Universal Serial Bus), SCSI (Small Computer Systems Interface), Fibre Channel, CAN (Controller Area Network), Ethernet, RF (Radio Frequency), Infrared, etc. The device specific circuits 401 may provide additional hardware to enable the controller 400 to perform unique functions such as, but not limited to, motor control of a cartridge gripper. The device specific circuits 401 may comprise electronics that provide, by way of example but not limitation, Pulse Width Modulation (PWM) control, Analog to Digital Conversion (ADC), Digital to Analog Conversion (DAC), LCD controller, etc. In addition, all or part of the device specific circuits 401 may reside outside the controller 400.

While the automated data storage library 10 is described as employing a distributed control system, the present invention may be implemented in various automated data storage libraries regardless of control configuration, such as, but not limited to, an automated data storage library having one or more library controllers that are not distributed. A library controller may comprise one or more dedicated controllers of a prior art library. For example, there may be a primary controller and a backup controller. In addition, a library controller may comprise one or more processor nodes of a distributed control system. For example, the library controller may comprise the communication processor node 50 (FIG. 3) while the other processor nodes (if present) may assist the library controller and/or may provide backup or redundant functionality. In another example, the library controller may comprise communication processor node 50 and work processor node 52 working cooperatively while the other processor nodes (if present) may assist the library controller and/or may provide backup or redundant functionality. Still further, the library controller may comprise all of the processor nodes. Herein, library controller may comprise a single processor or controller or it may comprise multiple processors or controllers.

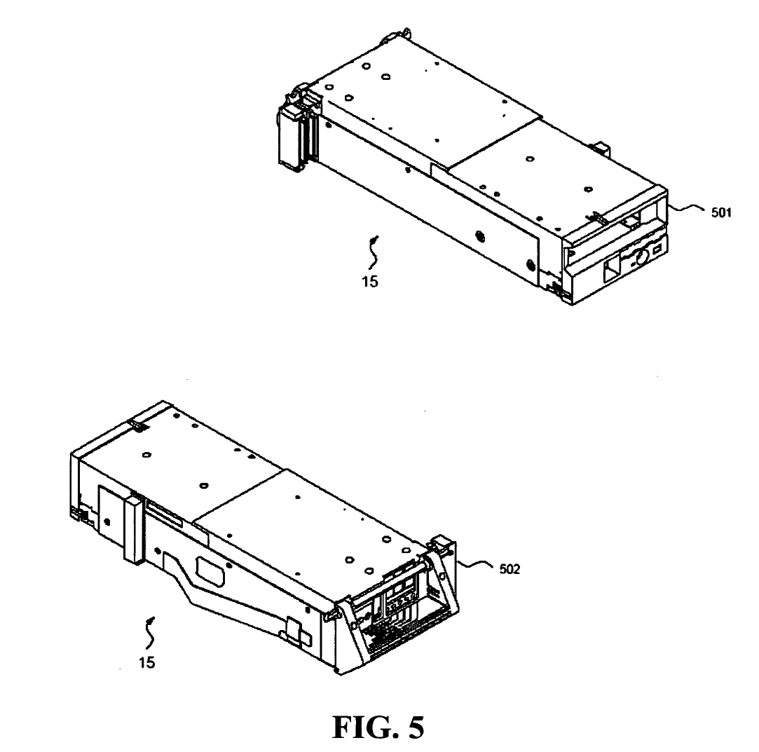

FIG. 5 illustrates an embodiment of the front 501 and rear 502 of a data storage drive 15. In the example of FIG. 5, the data storage drive 15 comprises a hot-swap drive canister. This is only an example and is not meant to limit the invention to hot-swap drive canisters. In fact, any configuration of data storage drive may be used whether or not it comprises a hot-swap canister.

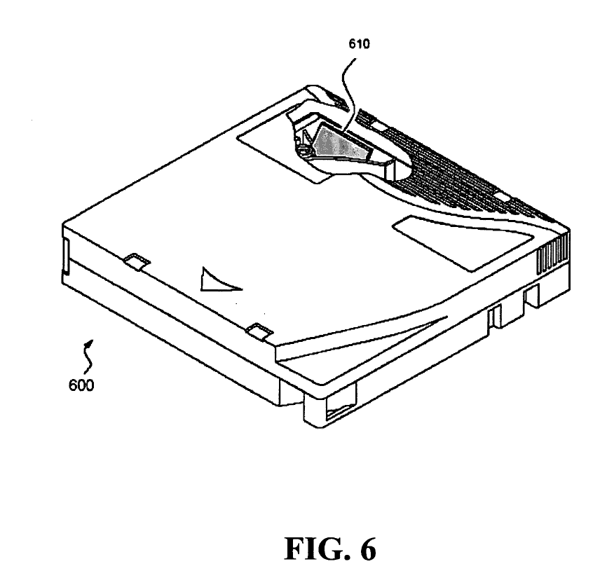

FIG. 6 illustrates an embodiment of a data storage cartridge 600 with a cartridge memory 610 shown in a cutaway portion of the Figure. A cartridge memory is a device associated with the data storage cartridge and may be used to store and/or retrieve information about the cartridge, or the media within the cartridge. For example, the cartridge memory may contain information about where data is stored on the data storage media, such as DSIT (Data Set Information Tables). In another example, the cartridge memory may contain information that duplicates or replaces the information on a cartridge bar code label, such as a cartridge VolSer (Volume Serial Number). A cartridge memory may be used by the drive and/or the library. The cartridge memory may be read only, or it may be updateable by a data storage drive and/or a library. One example of a cartridge memory is an RFID tag. The Ultrium LTO (Linear Tape Open) cartridge is one example of a cartridge that contains a cartridge memory. This is only an example and is not meant to limit the invention to cartridge memories. In fact, any configuration of data storage cartridge may be used whether or not it comprises a cartridge memory.

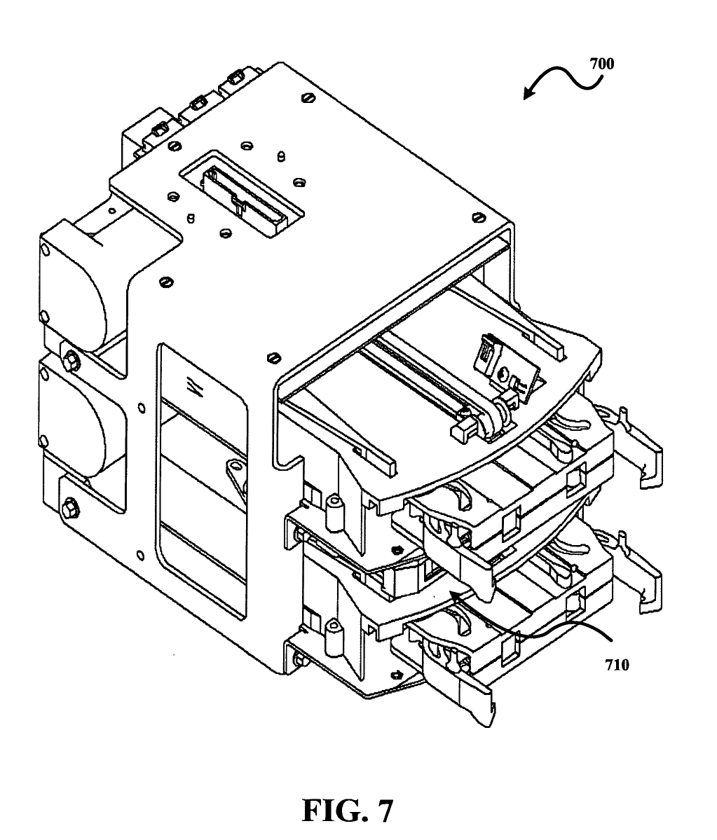

FIG. 7 illustrates an embodiment of a gripper 700 with a bar code scanner 710 shown between a pair of upper and lower gripper arms. This is only an example and is not meant to limit the invention to the use of bar code scanners.

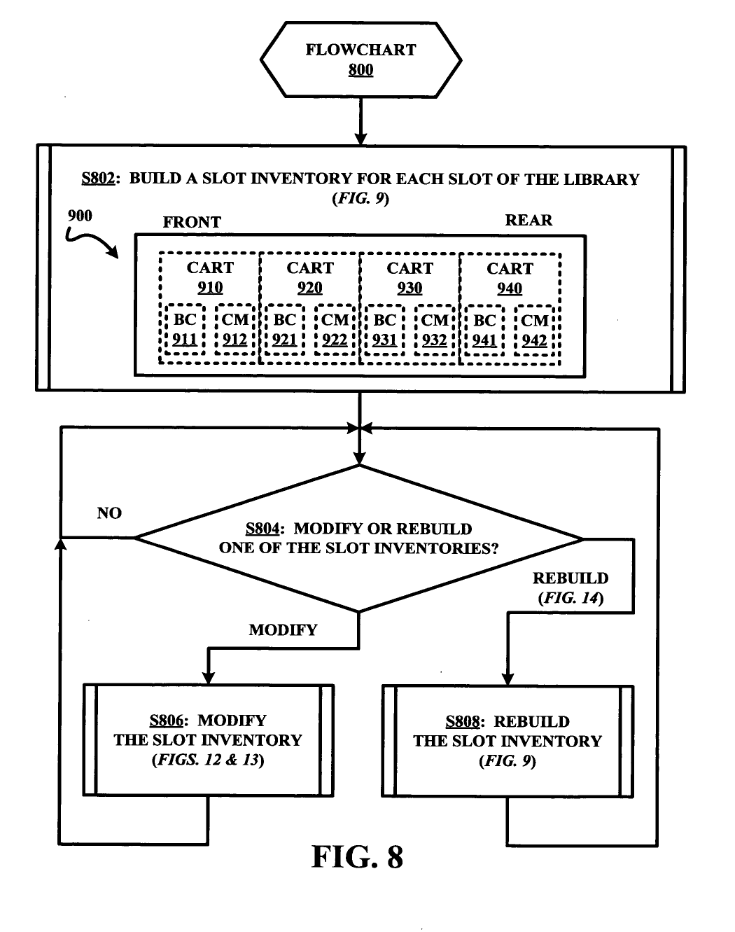

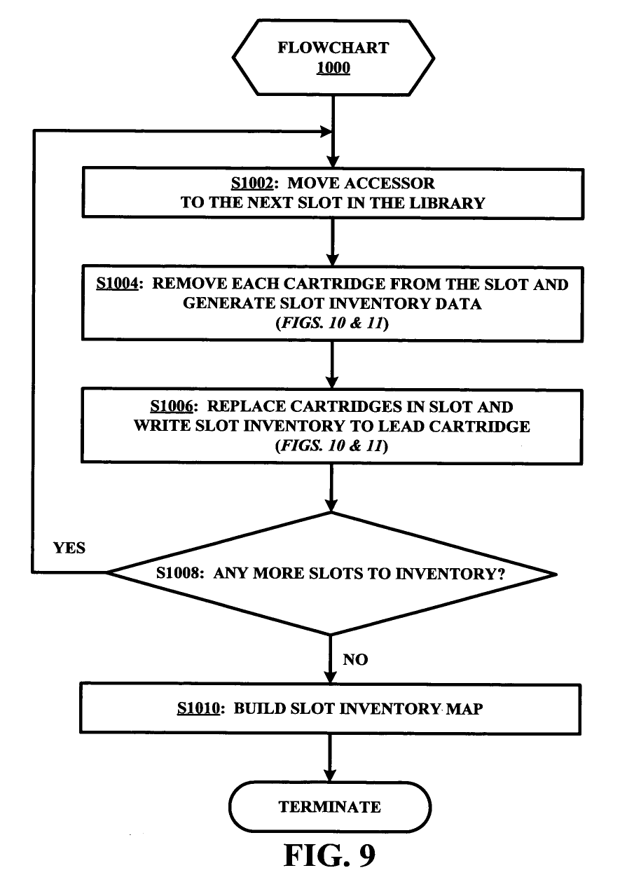

FIG. 8 illustrates a flowchart 800 representative of an inventory method of the present invention that is implemented by a library controller structurally configured in accordance with the teachings herein of FIG. 4. A stage S802 of flowchart 800 encompasses the library controller building slot inventory of each slot of a library. Stage S802 may be performed one time or after some trigger or operation. For example, at library installation, setup, configuration, power-on, after doors have been opened, etc. An exemplary slot 900 as shown is storing a cartridge (“CART”) 910 having a bar code label (“BC”) 911 and a cartridge memory (“CM”) 912, a cartridge 920 having a bar code label 921 and a cartridge memory 922, a cartridge 930 having a bar code label 931 and a cartridge memory 932, and a cartridge 940 having a bar code label 941 and a cartridge memory 942. Slot 900 is provided to facilitate an understanding of one embodiment of stage S802 as shown in FIG. 9. The invention will be described as using cartridge memories associated with the data storage media but one skilled in the art will recognize that alternatives may be used. For example, an RFID tag could be attached to or integrated with the data storage media. The library may read and/or write information from/to the cartridge memory through electrical contacts. Alternatively, the library may read and/or write information from/to the cartridge memory through a contactless system, such as with an RFID tag. Still further, the library may use a data storage drive to read and/or write information from/to the cartridge memory. Herein, cartridge memory refers to any medium or device that the library may use to read and/or write information from/to.

FIG. 9 illustrates a flowchart 1000 representative of a slot inventory building method of the present invention that is implemented by the library controller during stage S802 (FIG. 8). A stage S1002 of flowchart 1000 encompasses the library controller moving the accessor to the next slot in the library. A stage S1004 of flowchart 1000 encompasses the library controller controlling the accessor to remove each cartridge from the slot, and the library controller controlling a bar code scanner and/or a cartridge memory reader/writer to generate slot inventory data as each cartridge is being removed.

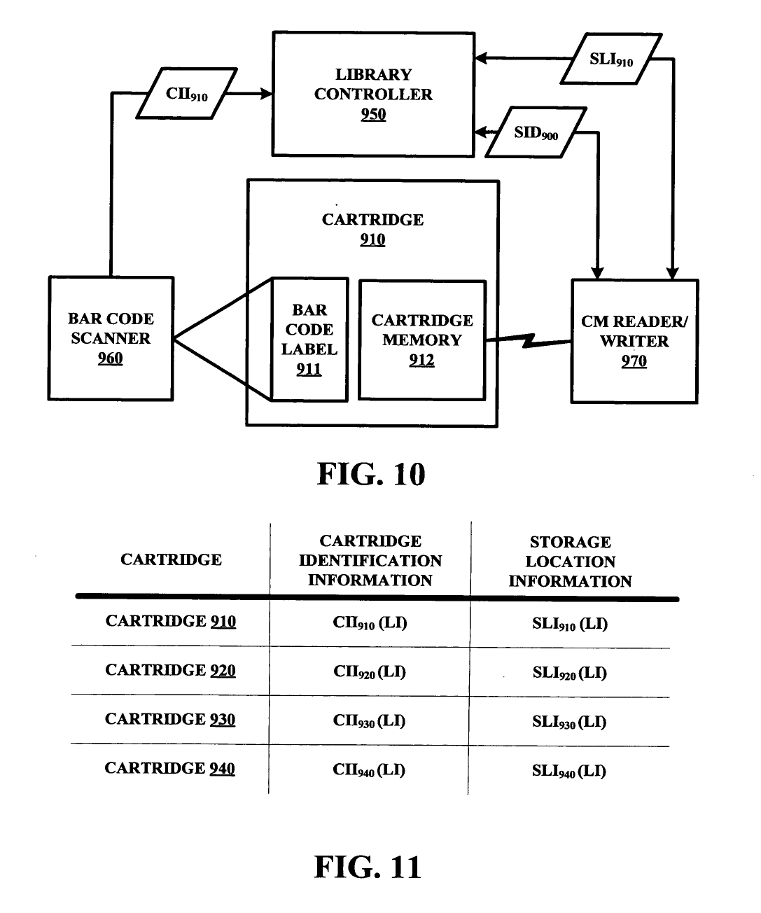

For example, as illustrated in FIG. 10, a library controller 950 acquires cartridge identification information CII₉₁₀ of a first removed cartridge 910 by instructing a bar code scanner 960 to scan bar code label 911 of removed cartridge 910. Alternatively, there may not be a bar code scanner 960. In this case, library controller 950 could acquire cartridge identification information CII₉₁₀ by instructing a cartridge memory reader/writer 970 to read cartridge memory 912. In addition to data related to identifying the cartridge (e.g., a cartridge bar code label value or serial number), the cartridge identification information CII₉₁₀ can additionally include a library identifier indicative of the library (e.g., a library serial number).

Library controller 950 can acquire storage location information SLI₉₁₀ of removed cartridge 910 by an accessor removing cartridge 910 as would be appreciated by those having ordinary skill in the art, and can further instruct a cartridge memory reader/writer 970 to write the acquired storage location information SLI₉₁₀ to cartridge memory 912. Alternatively, library controller 950 can acquire storage location information SLI₉₁₀ of removed cartridge 910 by instructing cartridge memory reader/writer 970 to read previously stored storage location information SLI₉₁₀ from cartridge memory 912. In either case, in addition to data related to a storage location of cartridge 910 in slot 900 (e.g., an element address, a frame/column/row address, or a XY coordinate), the storage location information SLI₉₁₀ can additionally include a library identifier indicative of the library (e.g., a library serial number). A library identifier allows library controller 950 to determine if the cartridge identification information and/or the cartridge location information was obtained from another library. For example, cartridge location information may not be valid if it was obtained from another library, where the location of the cartridge may be different from the current location of the cartridge.

As shown in FIG. 11, the acquisition of cartridge identification information CII (with or without a library identifier LI) and storage location information SLI (with or without a library identifier LI) is repeated for a sequential removal of cartridges 920, 930 and 940. In a preferred embodiment, the cartridge label can be read and/or the cartridge memory can be read/written from the front cartridge of slot 900. As a result, the last cartridge would not have to be removed from the slot.

Referring again to FIG. 9, a stage S1006 of flowchart 1000 encompasses the library controller controlling the accessor to replace the cartridges in the slot and to write a slot inventory including part or all of the slot inventory data to a lead cartridge. For example, as shown in FIGS. 8 and 10, a replacing of the cartridges 910-940 yields cartridge 910 as the lead cartridge whereby library controller 950 instructs cartridge memory reader/writer 970 to write part or all of the slot inventory data SID₉₀₀ of the slot inventory (FIG. 11) to cartridge memory 912 of lead cartridge 910. In a preferred embodiment, the slot inventory data is written to each cartridge 910-940 as they are inserted into the storage slot. As a result, each cartridge in the slot will contain the slot inventory for cartridges behind it.

Referring again to FIG. 9, a stage S1008 of flowchart 1000 encompasses the library controller proceeding to repeat stages S1002-S1006 for any slots of the library requiring a slot inventory. Otherwise, the library controller proceeds to a stage S1010 of flowchart 1000 to build a slot inventory map including a listing of each cartridge and/or each lead cartridge of the library slots. Flowchart 1000 is terminated upon completion of stage S1010.

Referring again to FIG. 8, upon completion of stage S802, the library controller proceeds to a stage S804 of flowchart 800 to determine whether a modification or a rebuilding of a slot inventory is required. The completion of stage S802 may occur at a different time, or based on a different trigger, than stage S804. For example, stage S802 may occur as the result of a library configuration or setup and stage S804 may occur as the result of a cartridge move operation. In one embodiment, a modification of a slot inventory is required in response to a deliberate change of the slot inventory in the form of a commanded removal of a cartridge and/or an insertion of an additional cartridge. If required, the library controller proceeds to a stage S806 of flowchart 100 to modify the slot inventory.

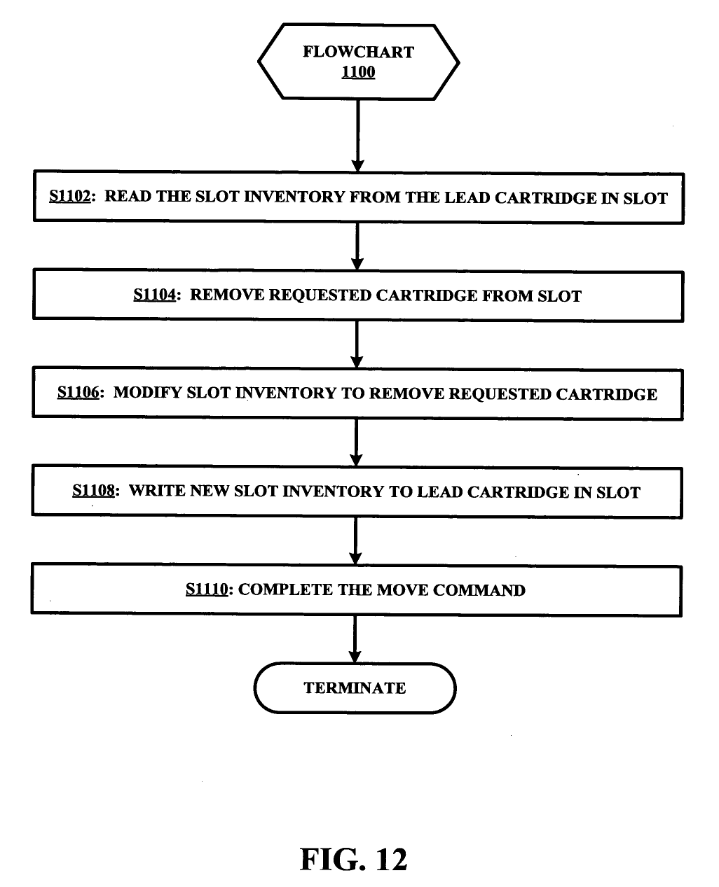

FIG. 12 illustrates a flowchart 1100 representative of a slot inventory modification method of the present invention responsive to a move command directed to removing one of the inventoried cartridges from the slot, such as, for example, a move command directed to removing cartridge 920 from a slot 900 as shown in FIG. 8. A stage S1102 of flowchart 1100 encompasses the library controller instructing a cartridge memory reader/writer to read the slot inventory from the lead cartridge in the slot, such as, for example, library controller 950 instructing cartridge memory reader/writer 970 to read the slot inventory data SID₉₀₀ of the slot inventory from lead cartridge 910 in slot 900 as shown in FIG. 10. Alternatively, if the cartridge map is already stored in a memory of the library controller, there may not be a need to read the slot inventory from the lead cartridge 910. A stage S1104 of flowchart 1100 encompasses an accessor removing the requested cartridge from the slot, such as, for example, an accessor removing cartridge 920 from slot 900. In this example, the library controller may have to remove the lead cartridge 910 in order to gain access to cartridge 920.

A stage S1106 of flowchart 1100 encompasses the library controller modifying the slot inventory to remove the requested cartridge, such as, for example, library controller 950 removing cartridge identification information CII₉₂₀ (FIG. 11) and storage location information SLI₉₂₀ (FIG. 11) from the slot inventory. Alternatively, there may not be any storage location information SLI₉₂₀ in the slot inventory. A stage S1108 of flowchart 1100 encompasses the library controller instructing cartridge memory reader/writer to write the modified slot inventory data of the slot inventory to the cartridge memory of the lead cartridge, such as, for example, library controller 950 instructing cartridge memory reader/writer 970 to write the modified slot inventory data SID₉₀₀ of the slot inventory to cartridge memory 912 of lead cartridge 910 as shown in FIG. 10. As stage S1110 of flowchart 1100 encompasses the library controller completing the move command, such as, for example, replacing lead cartridge 910 back in slot 900. Alternatively, step S1110 may be completed prior to step S1108 or S1104.

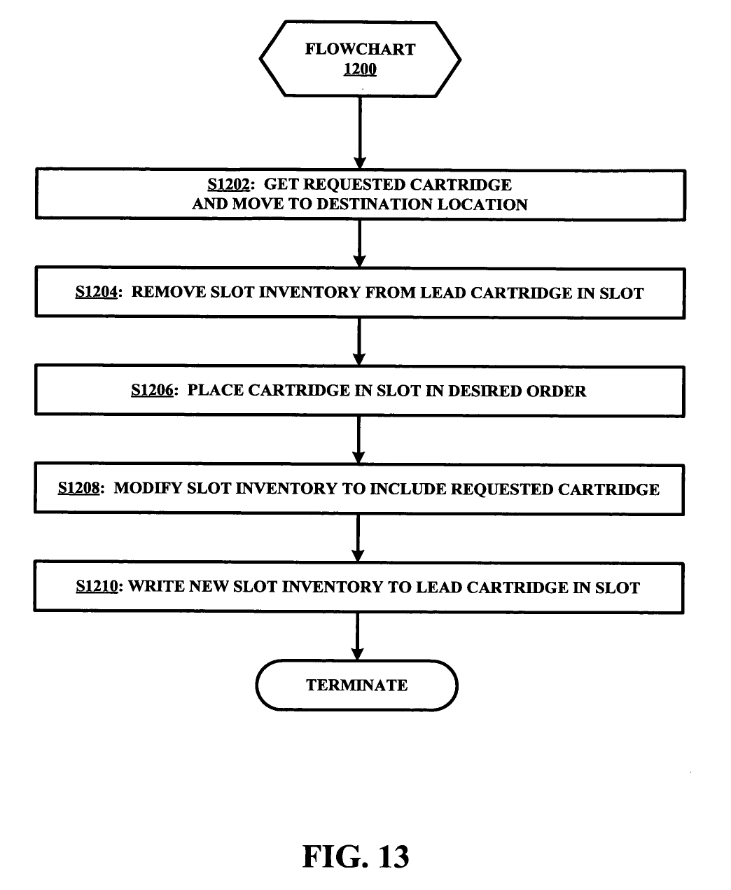

FIG. 13 illustrates a flowchart 1200 representative of a slot inventory modification method of the present invention responsive to a move command directed to inserting a cartridge into the slot. A stage S1202 of flowchart 1200 encompasses an accessor getting and moving the requested cartridge to a destination location or slot. An optional stage S1204 of flowchart 1200 encompasses the library controller instructing the cartridge reader/writer to remove the slot inventory from the lead cartridge in the slot, such as, for example, library controller 950 instructing cartridge reader/writer 970 to remove the slot inventory data SID₉₀₀ of the slot inventory from lead cartridge 9210 in slot 900 as shown in FIG. 10. This stage is optional because it may be desirable to move this cartridge into the lead position of the slot and/or it may be desirable to have each cartridge in a slot contain the slot inventory of every cartridge behind that cartridge.

A stage S1206 of flowchart 1200 encompasses the accessor placing any cartridges in the slot in a desired order. In a preferred embodiment, the cartridge replaces the lead cartridge in the slot (i.e. is inserted in front of the previous lead cartridge). Alternatively, the cartridge may be inserted before or after any cartridge in the slot. A stage S1208 of flowchart 1200 encompasses the library controller modifying the slot inventory to add the requested cartridge, such as, for example, library controller 950 adding cartridge identification information and/or storage location information of the requested cartridge to the slot inventory. A stage S1210 of flowchart 1200 encompasses the library controller instructing cartridge memory reader/writer to write the modified slot inventory data of the slot inventory to the cartridge memory of the lead cartridge, such as, for example, library controller 950 instructing cartridge memory reader/writer 970 to write the modified slot inventory data SID₉₀₀ of the slot inventory to cartridge memory 912 of lead cartridge 910 as shown in FIG. 10. If the order of any other cartridges in the slot were affected by the inserted cartridge then a slot inventory may be written to any affected cartridges, indicating the cartridges that are behind that affected cartridge, as was discussed. Stage S1210, or any other writing of slot inventory to any cartridge, may occur at any time before, during, or after the placing of the cartridge(s) in the slot.

Referring again to FIG. 8, in one embodiment, a rebuilding of a slot inventory is required in response to an unanticipated change of the slot inventory in the form of an actual location of a cartridge being different or presumed to being different than the inventoried location of the cartridge. If required, the library controller proceeds to a stage S808 of flowchart 800 to rebuild the slot inventory in accordance with flowchart 1000 shown in FIG. 9.

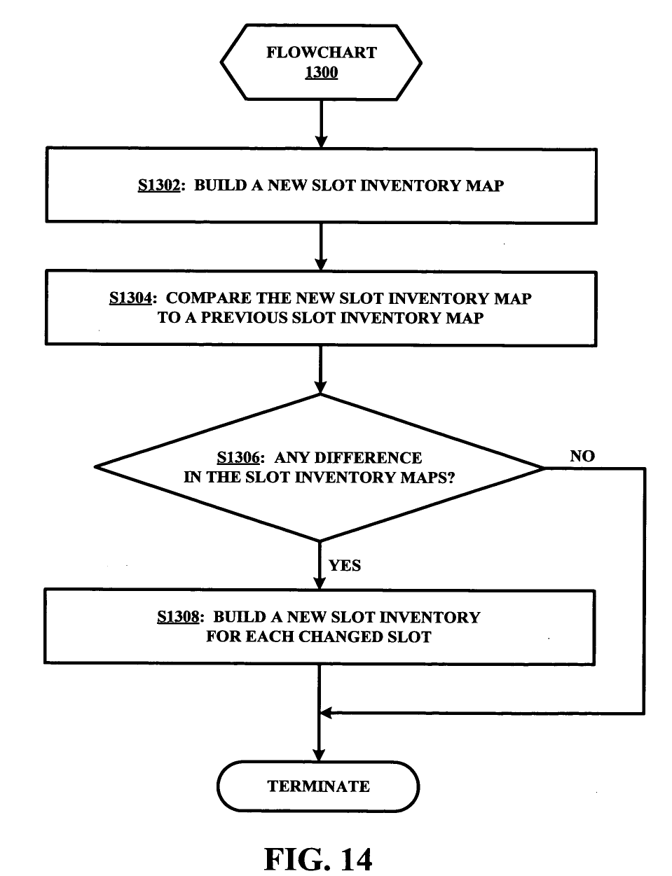

FIG. 14 illustrates a flowchart 1300 representative of a rebuild slot inventory triggering method of the present invention. A stage S1302 of flowchart 1300 encompasses the library controller to build a new inventory map via the bar code scanner and/or the cartridge memory reader/writer listing all lead cartridges of the slots of the library in response to any loss of inventory, a power cycle of the library, a manual opening of the library or any other event possibly warranting a full or partial re-inventory of the library. If a cartridge has been removed, inserted, or moved, the lead cartridge of the slot may change state. For example, if a cartridge is removed, the lead cartridge may be missing altogether, or it may have been moved to another slot. A stage S1304 of flowchart 1300 encompasses the library controller comparing the new slot inventory map to a previous slot inventory map. The library controller proceeds to terminate flowchart 1300 in view of an absence of any difference between the slot inventory maps. Otherwise, the library controller proceeds to build a new slot inventory in accordance with flowchart 1000 (FIG. 9) for each slot presumed to be changed in view of each difference between the slot inventory maps. In the case where the cartridge memory comprises a contactless device, such as an RFID tag, the library controller may be able to read all of the cartridges in the slot. In this case, the rebuild slot inventory triggering method comprises a change in the slot inventory map of any cartridge in the slot, not just the lead cartridge.

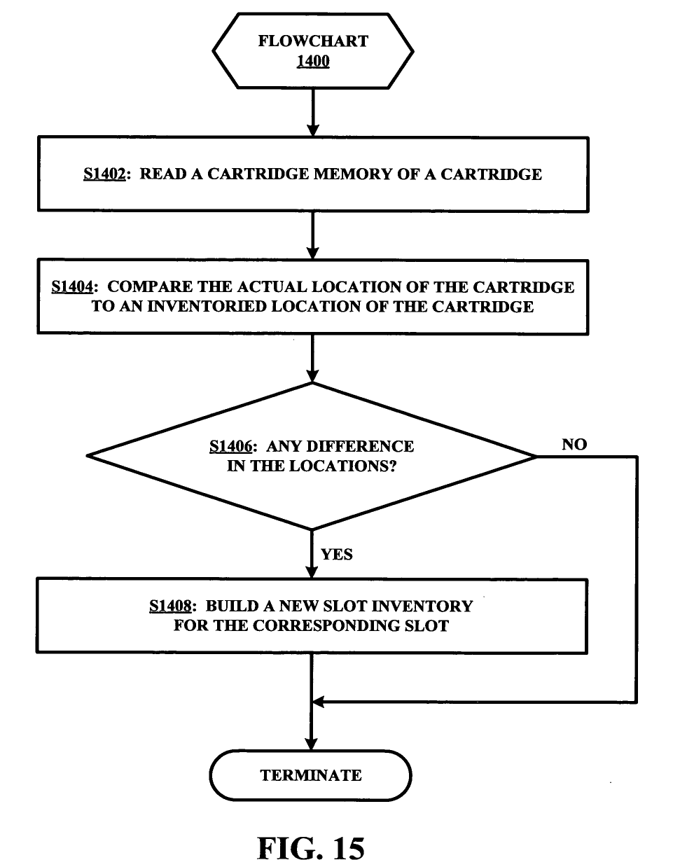

FIG. 15 illustrates a flowchart 1400 representative of another rebuild slot inventory triggering method of the present invention. A stage S1402 of flowchart 1400 encompasses the library controller instructing the cartridge memory reader/writer to read storage location information from a cartridge memory of a cartridge. A stage S1404 of flowchart 1400 encompasses the library controller comparing the actual location of the cartridge to an inventoried location of the cartridge as indicated by the storage location information. The library controller proceeds to terminate flowchart 1400 in view of an absence of any difference between the locations. Otherwise, the library controller proceeds to build a new slot inventory in accordance with flowchart 1000 (FIG. 9) for the corresponding slot which is presumed to be changed in view of the difference in locations. In the case where the cartridge memory comprises a contactless device, such as an RFID tag, the library controller may be able to read all of the cartridges in the slot. In this case, the rebuild slot inventory triggering method comprises a change in the storage location information for any cartridge in the slot, not just the lead cartridge.

In a preferred embodiment, the library does not support an unexpected modification of the storage slot. For example, the library may not support direct human entry of cartridges into storage slots, or it may only support such operations when followed with the slot inventory method of FIG. 9. In this case, there may not be a rebuild slot inventory triggering method of FIGS. 14 and 15. In addition, there may not be a need for the storage location information, as was discussed.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by a processor to perform operations for building an inventory of a slot storing a plurality of cartridges, the operations comprising:
generating slot inventory data including cartridge identification information of each cartridge behind a lead cartridge in the slot; and
writing a slot inventory including the slot inventory data to a cartridge memory of the lead cartridge.

2. The signal bearing medium of claim 1, wherein the slot inventory data further includes storage location information of the slot.

3. The signal bearing medium of claim 1, wherein the operations further comprise:
acquiring the cartridge identification information of each cartridge by at least one of scanning a bar code label of at least one cartridge and reading information from the cartridge memory of at least one cartridge.

4. The signal bearing medium of claim 1, wherein the slot inventory data further includes a library identifier indicative of an automated data storage library that wrote the slot inventory.

5. The signal bearing medium of claim 1, wherein the operations further comprise:
modifying the slot inventory as written to the cartridge memory of the lead cartridge in response to a command to remove one of the cartridges stored in slot; and
writing the modified slot inventory to the cartridge memory of the lead cartridge.

6. The signal bearing medium of claim 1, wherein the operations further comprise:
modifying the slot inventory as written to the cartridge memory of the lead cartridge in response to a command to store an additional cartridge in the slot; and
writing the modified slot inventory to the cartridge memory of the lead cartridge.

7. The signal bearing medium of claim 1, wherein the operations further comprise:
regenerating the slot inventory data in response to a change in cartridge identification information of one of the cartridges in the slot.

8. The signal bearing medium of claim 2, wherein the operations further comprise:
regenerating the slot inventory data in response to a difference in an actual location and a location specified by the storage location information of one of the cartridges in the slot.

9. A library controller of an automated data storage library, the library controller comprising:
a processor; and
a memory storing instructions operable within the processor for building an inventory of a slot storing a plurality of cartridges, the instructions being executed for:
generating slot inventory data including cartridge identification information of each cartridge behind a lead cartridge in the slot; and
writing a slot inventory including the slot inventory data to a cartridge memory of the lead cartridge.

10. The library controller of claim 9, wherein the slot inventory data further includes storage location information of the slot.

11. The library controller of claim 9, wherein the instructions are further executed for:
acquiring the cartridge identification information of each cartridge by at least one of scanning a bar code label of at least one cartridge and reading information from the cartridge memory of at least one cartridge.

12. The library controller of claim 9, wherein the slot inventory data further includes a library identifier indicative of the automated data storage library that wrote the slot inventory.

13. The library controller of claim 9, wherein the instructions are further executed for:
modifying the slot inventory as written to the cartridge memory of the lead cartridge in response to a command to remove one of the cartridges stored in slot; and
writing the modified slot inventory to the cartridge memory of the lead cartridge.

14. The library controller of claim 9, wherein the instructions are further executed for:
modifying the slot inventory as written to the cartridge memory of the lead cartridge in response to a command to store an additional cartridge in the slot; and
writing the modified slot inventory to the cartridge memory of the lead cartridge.

15. The library controller of claim 9, wherein the instructions are further executed for:
regenerating the slot inventory data in response to a change in cartridge identification information of one of the cartridges in the slot.

16. The library controller of claim 10, wherein the instructions are further executed for:
regenerating the slot inventory data in response to a difference in an actual location and a location specified by the storage location information of one of the cartridges in the slot.

17. A method for building an inventory of a slot storing a plurality of cartridges, the method comprising:
generating slot inventory data including cartridge identification information of each cartridge behind a lead cartridge in the slot; and
writing a slot inventory including the slot inventory data to a cartridge memory of a lead cartridge among the cartridges.

18. The method of claim 17, wherein the slot inventory data further includes storage location information of the slot.

19. The method claim 17, further comprising:
acquiring the cartridge identification information of each cartridge by at least one of scanning a bar code label of at least one cartridge and reading information from the cartridge memory of at least one cartridge.

20. The method claim 17, further comprising:
modifying the slot inventory as written to the cartridge memory of the lead cartridge in response to a command to remove one of the cartridges stored in slot; and
writing the modified slot inventory to the cartridge memory of the lead cartridge.

21. The method claim 17, further comprising:
modifying the slot inventory as written to the cartridge memory of the lead cartridge in response to a command to store an additional cartridge in the slot; and
writing the modified slot inventory to the cartridge memory of the lead cartridge.

22. The method claim 17, further comprising:
regenerating the slot inventory data in response to a change in cartridge identification information of one of the cartridges in the slot.

23. The method claim 18, further comprising:
regenerating the slot inventory data in response to a difference in an actual location and a location specified by the storage location information of one of the cartridges in the slot.
